(19) United States
(12) Patent Application Publication
(10) Pub. No.: US 2024/0300430 A1
(43) Pub. Date: Sep. 12, 2024

(54) CABLE ATTACHMENT STRUCTURE AND CABLE ATTACHMENT METHOD

(71) Applicant: Toyota Jidosha Kabushiki Kaisha, Toyota-shi (JP)

(72) Inventors: Yuma ITO, Toyota-shi (JP); Masahiro OGAWA, Nagoya-shi (JP)

(73) Assignee: Toyota Jidosha Kabushiki Kaisha, Toyota-shi (JP)

(21) Appl. No.: 18/532,188

(22) Filed: Dec. 7, 2023

(30) Foreign Application Priority Data
Mar. 9, 2023 (JP) 2023-036943

(51) Int. Cl. B60R 16/033; B60R 16/02

(52) U.S. Cl. CPC B60R 16/033; B60R 16/0215

(57) ABSTRACT

A base portion of the flag terminal is placed on the upper surface of the front wall of the casing, the shield of the wire harness is crimped to the crimping portion, and the base is screwed to the stud bolt by the fastening nut, so that the front wall is fixed to support the wiring harness. A ferrite core is attached to the bracket projecting from the base portion into the junction portion, and two electrical wires are passed through the through hole of the ferrite core. As a result, the ferrite core can effectively reduce emission of electromagnetic noise due to the common mode current generated in the electrical wires.

### CROSS-REFERENCE TO RELATED APPLICATION

This application claims priority to Japanese Patent Application No. 2023-036943 filed on Mar. 9, 2023, incorporated herein by reference in its entirety.

### BACKGROUND

### 1. Technical Field

The present disclosure relates to cable attachment structures and cable attachment methods.

### 2. Description of Related Art

Japanese Unexamined Patent Application Publication No. 2021-163797 (JP 2021-163797 A) discloses an anti-electromagnetic noise member. This anti-electromagnetic noise member includes: a body (anti-electromagnetic noise member body) holding magnetic core parts in a holding member made of a non-conductive material; and an attachment member for attaching the body to a vehicle. A wire harness includes insulation-coated conductor wires, and portions of the insulation-coated conductor wires are not covered by an electromagnetic shield member. In the anti-electromagnetic noise member, these portions of the insulation-coated conductor wires of the wire harness are inserted through the magnetic core parts. The body is fixed to a fixing portion of the attachment member. The electromagnetic shield member of the wire harness is electrically connected to a connection portion of the attachment member by being fastened to the connection portion. The attachment member is attached to a ground portion of the vehicle, so that the electromagnetic shield member is thus grounded.

### SUMMARY

With an increase in output of electrified powertrains, higher voltage systems have been used in vehicles, and it has been a challenge to ensure high electromagnetic compatibility (EMC) performance, namely both low electromagnetic susceptibility (EMS) and low electromagnetic interference (EMI) caused by electromagnetic noise, for such systems.

A wire harness including two electrical wires, namely a P-wire and an N-wire, and a braided shield surrounding the two electrical wires is used as a cable for connecting a battery unit and a motor unit. An inverter device for converting direct current power supplied from the battery unit to alternating current power to be used in a motor is provided in the motor unit.

When the inverter device is provided in the motor unit, a common-mode current is generated between the two electrical wires of the wire harness connecting the motor unit and the battery unit. When the common mode current is generated in the wire harness, electromagnetic noise caused by the common mode current is emitted from the braided shield. The electromagnetic noise emitted from the wire harness can be reduced by mounting a ferrite core on the wire harness.

However, when the wire harness is connected to the battery unit and the motor unit, the braided shield is connected to housings and is grounded, and the electrical wires are connected and attached to the battery unit and the motor unit inside the housings. The ferrite core is mounted on the wire harness by passing the wire harness with the unstripped braided shield through a through hole of the ferrite core outside the housings. Therefore, even the wire harness with the ferrite core does not have a desired electromagnetic noise reduction effect, and there is room for improvement in attachment of the wire harness.

The present disclosure was made in view of the above circumstances, and it is an object of the present disclosure to provide a cable attachment structure and cable attachment method that can effectively reduce emission of electromagnetic noise.

In order to achieve the above object, a cable attachment structure of the present disclosure includes:
a cable including in an outer peripheral portion of the cable a shield for shielding an electrical wire inside the cable;
a metal housing that houses a storage battery or a powered device, that has a connection space where the cable is connected, and that is electrically connected to a vehicle body, the powered device being a device to which power is supplied from the electrical wire connected to the storage battery; and
a metal terminal member including a support portion, a crimping portion, and a bracket, the support portion being attached to a housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall.
   The cable is attached to the housing wall via the terminal member with the shield crimped by and connected to the crimping portion and with the electrical wire inserted through a through hole of a core-shaped magnetic body located in the connection space and attached to the bracket.

The above cable attachment structure uses the cable including in its outer peripheral portion the shield for shielding the electrical wire inside the cable. The storage battery and the powered device are connected by the electrical wire of the cable to supply power of the storage battery to the powered device. The housing is made of metal and is electrically connected to the vehicle body. The housing has the connection space where the electrical wire is connected to the storage battery or powered device housed in the housing.

When connecting the electrical wire to the storage battery or powered device housed in the housing, the cable is attached to the housing by using the metal terminal member. The terminal member includes the support portion, the crimping portion, and the bracket. The support portion is attached to the housing wall adjacent to the connection space. The crimping portion is a part of the support portion attached to the housing wall that is located outside the connection space. The cable can be supported by the support portion with the shield of the cable being crimped by and connected to the crimping portion. The bracket is placed on the support portion, and is located in the connection space by the support portion being attached to the housing wall. The shield of the cable is crimped by and connected to the crimping portion and is thus attached to the terminal member. The electrical wire of the cable is inserted through the through hole of the core-shaped magnetic body located in the connection space and attached to the bracket.

The cable is thus attached to the housing wall via the terminal member, and the wire not shielded by the shield can be surrounded by the core-shaped magnetic body located in the connection space inside the housing. This can reduce a common mode current flowing in the cable, and can thus effectively reduce emission of electromagnetic noise from the cable.

A cable attachment method according to the present disclosure includes attaching a cable including a wire and a shield for shielding the wire to a metal housing by using a metal terminal member, the housing being a housing that houses a storage battery or a powered device and has a connection space where the cable is connected, and the powered device being a device to which power is supplied from the wire connected to the storage battery, wherein when attaching the cable to the housing, the cable is attached to a housing wall via the terminal member with the shield crimped by and connected to a crimping portion and with the wire inserted through a through hole of a core-shaped magnetic body located in the connection space and attached to a bracket, the terminal member including a support portion, the crimping portion, and the bracket, the support portion being attached to the housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall.

According to the present disclosure, the cable can be easily attached to the housing, and the core-shaped member can be mounted on the wire not shielded by the shield in the connection space in the housing. Therefore, emission of electromagnetic noise can be effectively reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of main parts of a vehicle according to this embodiment;

FIG. 2 is a perspective view of the main parts of the battery unit showing the attachment of the wire harness;

FIG. 3 is a plan view of the main parts of the battery unit showing the attachment of the wire harness;

FIG. 4 is a diagram showing an outline of changes in intensity with respect to frequency of electromagnetic noise.

### DETAILED DESCRIPTION OF EMBODIMENTS

Hereinafter, an embodiment of the disclosure will be described with reference to drawings.

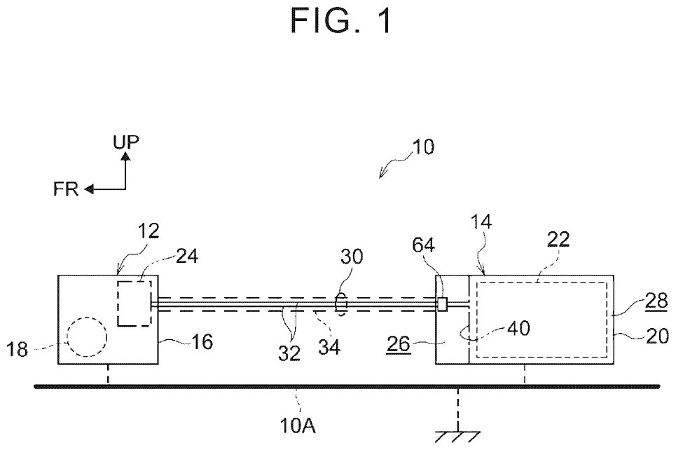

FIG. 1 shows a schematic configuration diagram of main parts of a vehicle 10 according to the present embodiment. In the drawings, the front side of the vehicle is indicated by an arrow FR, the left side in the vehicle width direction is indicated by an arrow HL, and the upward direction is indicated by an arrow UP.

A vehicle 10 according to the present embodiment is a battery electric vehicle (BEV) including an electric motor as a drive source for running. The vehicle 10 may be a fuel cell electric vehicle (FCEV). Further, the vehicle 10 may be a hybrid electric vehicle (HEV) or a plug-in hybrid electric vehicle (PHEV) that includes an engine (internal combustion engine) in addition to a motor as a drive source for running.

As shown in FIG. 1, the vehicle 10 has a motor unit 12 and a battery unit 14. The motor unit 12 has a motor 18 housed in a metal casing 16 as a housing, and the battery unit 14 has a battery 22 as a storage battery housed in a metal (for example, aluminum) casing 20 as a housing.

A motor unit 12 is mounted on the front side of the vehicle body 10A of the vehicle 10, and a battery unit 14 is mounted on the rear side of the motor unit 12 (for example, the middle portion in the longitudinal direction of the vehicle). Each of casings 16 and 20 is electrically connected and grounded to body 10A by being fixed to body 10A. The motor unit 12 may be mounted on the vehicle rear side of the vehicle 10, or the motor unit 12 may be mounted on each of the vehicle front side and the vehicle rear side.

The motor 18 is an AC motor driven by AC power (for example, three-phase AC power), and the motor unit 12 contains an inverter device 24 for converting DC power into AC power in a casing 16. The inverter device 24 functions as a powered device in this embodiment. In addition to the inverter device 24, the motor unit 12 may integrally accommodate a speed change (deceleration) mechanism and a control function. Further, when the vehicle 10 includes an engine (not shown) in addition to the motor 18 as a drive source for traveling, the engine may be housed integrally in the casing 16 of the motor unit 12.

The battery unit 14 has a junction portion 26 as a connection space (junction box) in the vehicle front portion of the internal space within the casing 20 and a battery portion 28 in the vehicle rear portion. In the battery portion 28, a plurality of battery cells (not shown) each storing DC power are aligned and arranged to form the battery 22. A plurality of battery cells are connected in series and in parallel so that the battery 22 is capable of outputting high-voltage DC power (60 V or more, for example, 200 V to 300 V in DC voltage in vehicles).

A wire harness 30 as a cable is routed between the motor unit 12 and the battery unit 14. The wire harness 30 has one end electrically connected to the inverter device 24 of the motor unit 12 and the other end electrically connected to the battery 22 in the junction portion 26 of the battery unit 14.

The wire harness 30 has two electrical wires 32 as core wires in which the conductor wires are coated with resin at the center of which the cross section is substantially circular (or substantially elliptical), and the electrical wires 32 are covered (surrounded) by a cylindrical shield 34. In the wire harness 30, an insulating resin is interposed between the electrical wires 32 and the shield 34, and the outer periphery of the shield 34 is covered by an exterior material using an insulating resin. The wire harness 30 is a two-core shield cable.

The shield 34 is formed in a flexible, substantially cylindrical shape (tube shape), and a shield that is formed in a tube shape by braiding a required number of conductive wires (braided shield) is applied as the shield 34. The shield 34 can be formed by spirally winding a band-shaped conductive metal foil such as copper foil into a tubular shape. The shield 34 covers the outer sides of the electrical wires 32 over the entire circumference and the entire length of the wire harness 30 so as to magnetically shield the electrical wires 32 from the outside of the wire harness 30.

In the wire harness 30, one of the two electrical wires 32 is used as a P-wire and the other as an N-wire. In the wire harness 30, the electrical wire 32 as a P-wire is electrically connected to the positive electrode of the inverter device 24 on the motor unit 12 side, and the electrical wire 32 as an N-wire is electrically connected to the negative electrode of the inverter device 24. On the side of the battery unit 14 of the wire harness 30, the electrical wire 32 serving as a P-wire is electrically connected to the positive electrode of the battery 22 in the junction portion 26, and the electrical wire 32 serving as an N-wire is electrically connected to the negative electrode of the battery 22.

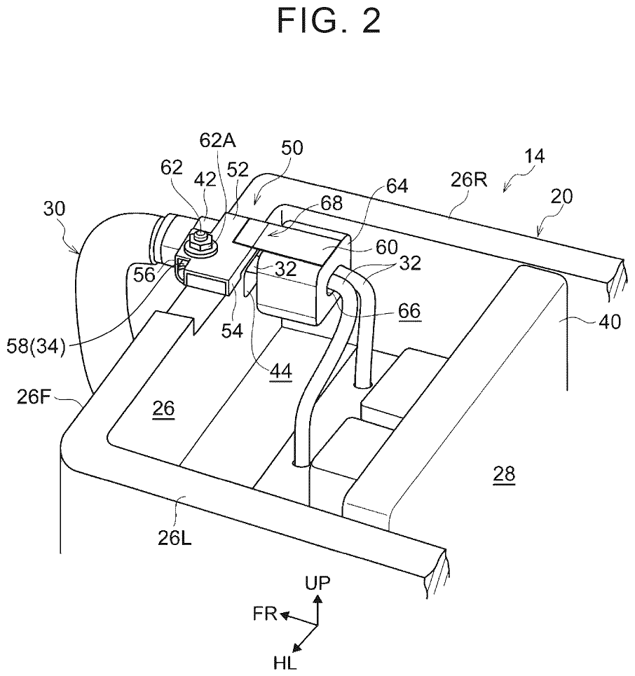

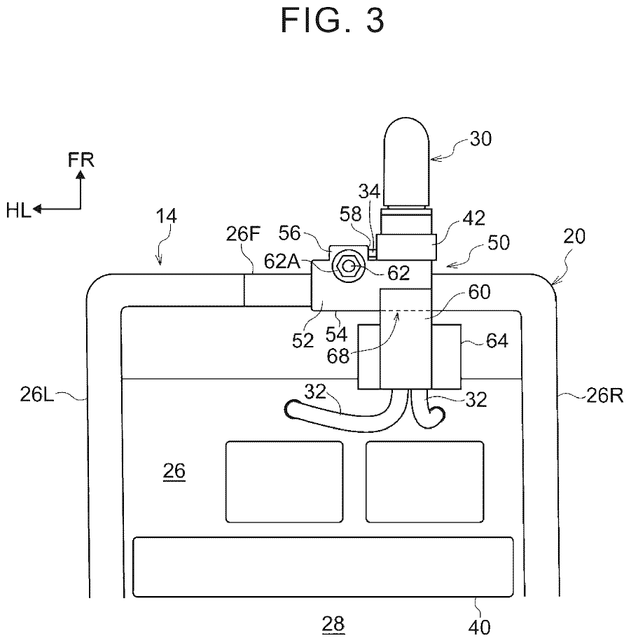

Next, the attachment of the wire harness 30 will be described using the battery unit 14 side as an example. FIG. 2 shows a perspective view of the main portion of the battery unit 14 as viewed obliquely from the rear left side of the vehicle, and FIG. 3 shows a plan view of the main portion of the battery unit 14 as viewed from the top.

As shown in FIGS. 1 to 3, in the battery unit 14 of the vehicle 10, a junction portion 26 is formed in the vehicle front side portion of the casing 20, and the junction portion 26 is separated from the battery portion 28 by a partition wall 40 installed in the casing 20.

As shown in FIGS. 2 and 3, the junction portion 26 is a space surrounded by a front wall 26F formed by the casing 20, right and left walls 26R, 26L, a bottom wall (not shown), and the partition wall 40. The inside of the junction portion 26 can be opened upward, and the upper opening of the junction portion 26 is tightly closed by a lid (not shown). In addition, in the junction portion 26, a control part (not shown) for controlling charging and discharging of the battery 22, for example, is accommodated on the bottom wall side.

In the wire harness 30 attached to the battery unit 14, a binding band 42 is wound around the exposed shield 34 by stripping the exterior material, and the shield 34 is bound by the binding band 42 to the insulating resin covering the electrical wires 32. Further, the shield 34 of the wire harness 30 is formed into a linear shape by pulling out the tip end side of the binding band 42 and twisting the wire harness 30. Furthermore, in the wire harness 30, the two electrical wires 32 are exposed so as to be connectable to the battery 22 by stripping the exposed insulating resin after the shield 34 is pulled out. A well-known method can be applied to terminal processing of such wire harness 30.

On the other hand, in the casing 20 of the battery unit 14 to which the wire harness 30 is attached, an insertion opening 44 as a connection port is formed in the front wall 26F of the junction portion 26. The insertion opening 44 has, for example, an oval shape (may be circular or elliptical), and is arranged in the upper part of the front wall 26F with its longitudinal direction along the upper edge (vehicle width direction) of the front wall 26F, It is formed so as to penetrate in the longitudinal direction of the vehicle.

The opening of the insertion opening 44 is sized so that the two electrical wires 32 extending out of the wire harness 30 can be inserted side by side. In the wire harness 30, the two electrical wires 32 exposed by stripping the exterior material, the shield 34, and the insulating resin are inserted into the junction portion 26 from the insertion opening 44, and the tip end portions of the two electrical wires 32 are subjected to necessary terminal processing and connected to the battery 22.

On the other hand, a flag terminal 50 as a terminal member is used to attach the wire harness 30 to the battery unit 14. The flag terminal 50 is made of conductive metal as a whole, and the flag terminal 50 is attached to the front wall 26F of the junction portion 26.

A substantially rectangular plate-shaped base portion 52 is formed on the flag terminal 50, and the width of the base portion 52 is larger than the thickness of the front wall 26F of the junction portion 26 (the dimension along the longitudinal direction of the vehicle). As a result, the base portion 52 of the flag terminal 50 can be placed on the upper surface of the front wall 26F of the junction portion 26 with its longitudinal direction being the vehicle width direction, and the base portion 52 can be placed on the front wall 26F. As a result, surface contact is made with the upper surface of the front wall 26F and electrical connection is established.

In the flag terminal 50, a leg portion 54 is formed on one widthwise side of a base portion 52, a connecting portion 56 is formed on the other widthwise side, and a crimping portion 58 is formed on the connecting portion 56. A fastening hole (not shown) is formed in the portion 52 near the connecting portion 56. A bracket 60 is arranged on the base portion 52 of the flag terminal 50.

The leg portion 54 is formed by bending the widthwise end portion of the base portion 52 toward one side of the base portion 52. The leg portion 54 may be formed over substantially the entire longitudinal direction of the base portion 52 as long as they avoid the insertion opening 44 of the front wall 26F, or may be formed at each of the longitudinal end portions. It may be formed at the end on the fastening hole side in the longitudinal direction of the base portion 52.

The connecting portion 56 is formed at one end of the base portion 52 in the longitudinal direction opposite to the leg portion 54, and the connecting portion 56 is bent in the same direction as the leg portion 54 by a predetermined width, is formed. As a result, the base portion 52 of the flag terminal 50 can be placed on the upper surface of the front wall 26F with the leg portion 54 on the junction portion 26 side and the connecting portion 56 on the front side of the vehicle (outside the casing 20).

The crimping portion 58 is formed at the bent end portion of the connecting portion 56. The crimping portion 58 can be formed, for example, by rounding the tip portion of the connecting portion 56, and the axial direction of the crimping portion 58 is the longitudinal direction of the base portion 52 (the vehicle width direction when arranged on the front wall 26F). The front end portion of the shield 34 pulled out from the wire harness 30 and twisted into a linear shape of a required length is inserted into the crimping portion 58, and the outer peripheral portion is crimped and deformed while the shield 34 is inserted (The shield 34 is fastened and fixed (crimped) by being crushed). The shield 34 of the wire harness 30 is crimped by the crimping portion 58 of the flag terminal 50. The shield 34 is thus electrically connected to the flag terminal 50. The wire harness 30 has the shield 34 crimped to the crimping portion 58 so that the longitudinal direction of the wire harness 30 crosses the longitudinal direction of the base portion 52, and the end of the wire harness 30 opposite to the connecting portion in the longitudinal direction of the base portion 52, and can be supported by a flag terminal 50.

When the base portion 52 of the flag terminal 50 is placed at a predetermined position on the front wall 26F, the stud bolt 62 is inserted into the fastening hole formed through the base portion 52, and the fastening nut 62A is screwed together with the stud bolt 62, so that the base portion 52 is fastened and fixed to the front wall 26F, and the flag terminal 50 is fixed to the front wall 26F.

On the other hand, the bracket 60 is in the shape of a conductive metal plate, and the longitudinal direction of the bracket 60 extends along the longitudinal direction of the wire harness 30 and protrudes toward the side opposite to the wire harness 30. The bracket 60 is electrically connected and fixed to the surface of the base portion 52 opposite to the leg portion 54 by welding or brazing (soldering) or the like. Further, the center position in the width direction of the bracket 60 is positioned to approximately overlap the center position in the longitudinal direction of the wire harness 30 attached to the flag terminal 50.

In the flag terminal 50, a ferrite core 64 as a core-shaped magnetic body is attached to the bracket 60. The ferrite core 64 is made of, for example, ferrite as a magnetic material containing iron oxide or the like as a main component, and is formed in a substantially elongated columnar shape (or a substantially elliptical columnar shape). A through hole 66 is formed through the central portion of 64 in the axial direction.

The through hole 66 of the ferrite core 64 is sized to allow the two electrical wires 32 of the wire harness 30 to pass through, and the through hole 66 has a substantially oval (or substantially elliptical) cross section. The outer peripheral surface of the ferrite core 64 is in surface contact with the surface of the bracket 60 on the side of the leg portion 54, and is attached integrally with the bracket 60 by winding a resin tape or the like. The attachment of the ferrite core 64 to the bracket 60 is not limited to this, and any configuration may be employed as long as the outer peripheral surface of the ferrite core 64 can be electrically connected to the bracket 60 and attached firmly.

The electrical wires 32 inserted into the front wall 26F are inserted into the through hole 66 of the ferrite core 64 attached to the bracket 60 of the flag terminal 50. A stepped portion 68 may be formed in the bracket 60. The stepped portion 68 is formed to adjust the thickness direction position (vertical position) of the bracket 60 between the base portion 52 side and the ferrite core 64 side in the longitudinal direction of the bracket 60. The stepped portion 68 reduces misalignment between the vertical position of the opening (for example, the center of the opening) of the insertion opening 44 of the front wall 26F and the opening (the center of the opening) of the through hole 66 of the ferrite core 64 when the flag terminal 50 is attached to the front wall 26F.

In the vehicle 10 configured as described above, the wire harness 30 is routed between the motor unit 12 and the battery unit 14, and the motor unit 12 and the battery unit 14 are electrically connected via the two electrical wires 32 of the wire harness 30. As a result, in the vehicle 10, the DC power of the battery 22 of the battery unit 14 is supplied (powered) to the inverter device 24 of the motor unit 12, so that the inverter device 24 converts the DC power into three-phase AC power of a required voltage. Also, the inverter device 24 supplies the electric power converted to AC power to the motor 18. As a result, the vehicle 10 runs while the motor 18 is rotationally driven by the DC power of the battery 22.

The wire harness 30 is attached to the battery unit 14 and the electrical wires 32 is connected to the battery 22. A flag terminal 50 is used to attach the wire harness 30 to the battery unit 14.

In the wire harness 30, the base side of the shield 34 (the side on which the exterior material remains) exposed by peeling off the exterior material of the tip part is fastened and fixed by the binding band 42, and the tip side is pulled out from the fastening and fixed part. It is formed into a linear shape of a required length by being twisted by A linear shield 34 is crimped by and connected to the crimping portion 58 of the flag terminal 50. Prior to the crimping connection of the shield 34 to the flag terminal 50 (or after crimping connection), the wire harness 30 is stripped of the insulating resin exposed by pulling out the shield 34, so that each wire harness 30 has a desired length. The two electrical wires 32 that have been separated are exposed.

The base portion 52 of the flag terminal 50 is placed on the top surface of the front wall 26F with the leg portion 54 and the crimping portion 58 facing downward, the leg portion 54 facing toward the junction portion 26 (inward), and the crimping portion 58 facing outward. At this time, the two electrical wires 32 of the wire harness 30 are inserted into the insertion opening 44 of the front wall 26F.

As a result, the flag terminal 50 is temporarily attached to the front wall 26F with the wire harness 30 on the outside of the front wall 26F and the bracket 60 on the junction portion 26 side, and the two electrical wires 32 are drawn into the junction portion 26.

In this state, the two electrical wires are inserted into the through hole 66 of the ferrite core 64, the ferrite core 64 with the electrical wires 32 inserted is fastened and fixed to the bracket 60, and the electrical wires 32 extending out of the through hole 66 of the ferrite core 64 are fixed to the battery 22. Thereafter, by screwing a fastening nut 62A onto the stud bolt 62 of the casing 20 inserted into the fastening hole of the base portion 52, the base portion 52 is fastened and fixed to the upper surface of the front wall 26F.

As a result, the flag terminal 50 is fixed to the front wall 26F of the casing 20, and the wire harness 30 with the shield 34 crimped by the flag terminal 50 is attached to the casing 20 of the battery unit 14 by connecting the electrical wires 32 to the battery 22. Since the flag terminal 50 is provided so that the wire harness 30 and the bracket 60 are substantially linear, the flag terminal 50 is fixed to the front wall 26F and the ferrite core 64 is attached to the bracket 60. The electrical wires 32 can be easily passed through the through hole 66 even in this state. Therefore, the space between the front wall 26F and the ferrite core 64 can be narrowed, and the ferrite core 64 does not occupy an unnecessarily large space.

Since the flag terminal 50 is attached with the base portion 52 in surface contact with the upper surface of the front wall 26F of the casing 20, the base portion 52 is reliably electrically connected to the casing 20 and grounded via the casing 20. In particular, since the base portion 52 is placed on the upper surface of the front wall 26F, the base portion 52 is in surface contact with the front wall 26F and the lid when the junction portion 26 is closed by the lid. Base portion 52 is effectively grounded.

In addition, since the crimping portion 58 to which the shield 34 of the wire harness 30 is crimped and connected to the flag terminal 50 is integrated with the base portion 52, the shield 34 of the wire harness 30 can be effectively (accurately) attached to the battery unit 14 side can be grounded.

Since the flag terminal 50 can support the wire harness 30 by crimping the shield 34, the wire harness 30 is attached to the casing 20 together with the flag terminal 50 by attaching the flag terminal 50 to the casing 20.

Further, the flag terminal 50 is integral with the bracket 60 to which the ferrite core 64 is attached. The bracket 60 is placed in the junction portion 26 with the flag terminal 50 being attached to the casing 20. Accordingly, in the flag terminal 50, the ferrite core 64 can be easily arranged in the junction portion 26, and the ferrite core 64 can be mounted only on the electrical wires 32 of the wire harness 30 without being arranged outside the casing 20.

Further, the bracket 60 is formed with a stepped portion 68, and the height position of the ferrite core 64 can be adjusted by the stepped portion 68. As a result, the position (height position) of the insertion opening 44 of the front wall 26F and the through hole 66 of the ferrite core 64 attached to the bracket 60 can be aligned, the electrical wires 32 can be prevented from being unnecessarily bent between the insertion opening 44 and the through hole 66 of the ferrite core 64, and mounting of the ferrite core 64 on the electrical wires 32 can be facilitated.

Further, in the wire harness 30, the electrical wires 32 have a required cross-sectional area (for example, 8 mm²) so as to supply power for driving the motor 18, and each of the electrical wires 32 is relatively strong. For this reason, the electrical wires 32 and the ferrite core 64 can be mutually supported within the junction portion 26, so that the electrical wires 32 and the ferrite core 64 are stably arranged within the junction portion 26.

On the other hand, the wire harness 30 is connected to the inverter device 24 inside the motor unit 12. Therefore, a common mode current is generated between the two electrical wires 32 of the wire harness 30. Also, in the wire harness 30, the motor unit 12 side and the battery unit 14 side are each grounded. Therefore, in the wire harness 30, a loop-shaped current path is formed between the shield 34 and the body 10A. Therefore, a common mode current (secondary common mode current) that causes electromagnetic noise flows through the shield 34 of the wire harness 30 due to the common mode current of the electrical wires 32.

By mounting the ferrite core 64 on the wire harness 30, the conduction impedance in the current path through which the common mode current flows can be increased, and the common mode current can be reduced. At this time, when the wire harness 30 is passed through the through hole 66 of the ferrite core 64 so as to surround the shield 34 together with the electrical wires 32 (when the ferrite core 64 is mounted so as to include the shield 34), the shield 34 is formed. Conductive impedance of the current path increases. Therefore, the ferrite core 64 cannot increase the conduction impedance of the path of the electrical wires 32. As a result, the common mode current generated in the electrical wires 32 cannot be reduced, and a secondary common mode current flows through the shield 34, and electromagnetic noise is emitted to the surroundings due to this secondary common mode current.

On the other hand, the flag terminal 50 used for attaching the wire harness 30 is provided with a bracket 60, and the flag terminal 50 has the bracket 60 arranged in the junction portion 26 and the ferrite core 64 is attached to the junction portion 26. Therefore, in the wire harness 30, the ferrite core 64 is mounted only on the electrical wires 32.

Thereby, the ferrite core 64 increases the conduction impedance in the current path formed by the electrical wires 32 and reduces the common mode current generated by the electrical wires 32. In the wire harness 30, the occurrence of a secondary common mode current in the current path including the shield 34 is suppressed by reducing the common mode current occurring in the electrical wires 32. Therefore, in the vehicle 10, emission of electromagnetic noise due to the secondary common-mode current flowing through the shield 34 of the wire harness 30 is reduced.

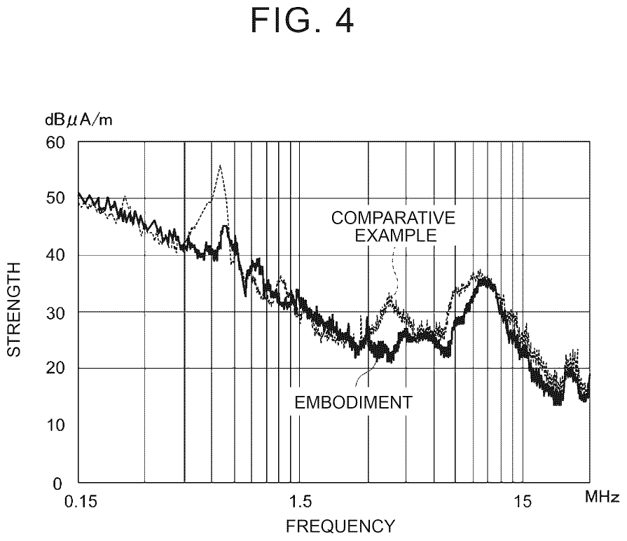

FIG. 4 schematically shows the intensity of electromagnetic noise emitted from the vehicle body of the vehicle 10. In FIG. 4, the ferrite core 64 is mounted on the electrical wires 32 in the junction portion 26 in this embodiment, and the terminal member in which the ferrite core 64 is not mounted (without the bracket 60) is used in the comparative example. In FIG. 4, the horizontal axis represents electromagnetic noise frequency (MHz), and the vertical axis represents electromagnetic noise intensity (noise level, dBμA/m).

As shown in FIG. 4, the vehicle 10 emits electromagnetic noise in a range from a low frequency range (0.15 MHz in FIG. 4) to a high frequency range (20 MHz in FIG. 4) (see Comparative Example).

In the present embodiment in which the ferrite core 64 is mounted only on the electrical wires 32 in the junction portion 26, emission of electromagnetic noise is reduced over the entire range from the low frequency range to the high frequency range as compared with the comparative example. In particular, in the frequency range higher than the intermediate frequency range (near 2 MHz in FIG. 4), electromagnetic noise is significantly reduced in this embodiment as compared with the comparative example.

Therefore, electromagnetic noise in the set frequency range can be effectively reduced by setting a frequency range for reducing electromagnetic noise and a target value (upper limit) of the intensity of electromagnetic noise and determining the axial dimension, longitudinal dimension (width dimension) as viewed in the axial direction, lateral dimension (length dimension) as viewed in the axial direction of the ferrite core 64.

In the embodiment described above, the flag terminal 50 is used to attach the wire harness 30 to the battery unit 14 and the ferrite core 64 is attached together with the wire harness 30. However, attachment of the wire harness 30 using the flag terminal 50 and the ferrite core 64 may be applied to attachment of the wire harness 30 to the motor unit 12 side. Attachment of the wire harness 30 using the flag terminal 50 and the ferrite core 64 may be applied to attachment of the wire harness 30 to each of the motor unit 12 side and the battery unit 14 side. In this case, the effect of reducing electromagnetic noise is not less than that in the case of attachment to one of the 12 side and the battery unit 14 side.

Also, the present embodiment does not limit the configuration of the flag terminal 50. The terminal member includes a supporting portion that is attached to the periphery of the opening of the housing to be electrically connected to the housing, a crimping portion that allows the cable to be supported by the supporting portion by crimping the shield of the cable, and a supporting portion. It is sufficient that it includes a bracket provided on the side opposite to the crimping portion and to which the core-shaped magnetic body is attached.

Furthermore, in this embodiment, the power of the battery 22 is supplied to the inverter device 24 through the wire harness 30. However, the powered device is not limited to the inverter device. The powered device may be a device that generates a common mode current in the electrical wire when power is supplied thereto or a device that may generate a common mode current in the electrical wire when power is supplied thereto. Emission of electromagnetic noise can thus be reduced.

On the other hand, when the vehicle 10 is provided with an engine in the front part of the vehicle, an exhaust pipe connected to the engine is supported by the body 10A and is passed under the body 10A and opened toward the rear of the vehicle. In such a vehicle 10, if the motor unit 12 is arranged in the rear part of the vehicle, the electromagnetic noise emitted from the wire harness 30 connecting the battery unit 14 and the motor unit 12 in the rear part of the vehicle becomes stronger. In such a vehicle 10, electromagnetic noise emitted from the rear part of the vehicle can be effectively reduced by attaching the wire harness 30 connected to the motor unit 12 on the rear side of the vehicle to the battery unit 14 side using the flag terminal 50, and mounting the ferrite core 64 on the flag terminal 50.

### Supplementary Note

(1) A cable attachment structure includes:
a cable including in an outer peripheral portion of the cable a shield for shielding an electrical wire inside the cable;
a metal housing that houses a storage battery or a powered device, that has a connection space where the cable is connected, and that is electrically connected to a vehicle body, the powered device being a device to which power is supplied from the electrical wire connected to the storage battery; and
a metal terminal member including a support portion, a crimping portion, and a bracket, the support portion being attached to a housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall, wherein
the cable is attached to the housing wall via the terminal member with the shield crimped by and connected to the crimping portion and with the electrical wire inserted through a through hole of a core-shaped magnetic body located in the connection space and attached to the bracket.

(2) In the cable attachment structure of (1),
the storage battery is housed in the housing, and the electrical wire of the cable is connected to the storage battery in the connection space.

(3) In the cable attachment structure of (1),
the powered device is housed in the housing, and the electrical wire of the cable is connected to the powered device in the connection space.

(4) In the cable attachment structure according to any one of (1) to (3),
the powered device is a device configured to generate a common mode current in the cable when supplied with power.

(5) In the cable attachment structure according to any one of (1) to (4),
the powered device is an inverter device configured to supply power to an electric motor used as a driving source for causing a vehicle to travel.

(6) In the cable attachment structure according to any one of (1) to (5),
the housing wall has an insertion hole through which the electrical wire extending out of the cable is inserted, and in the terminal member, the support portion is in a form of a plate and is in surface contact with an end face of the housing wall that contacts with a lid that closes the connection space, and the bracket protrudes from the support portion into the connection space, and the core-shaped magnetic body is attached to the bracket in such a manner that a direction in which the through hole extends coincides with a direction in which the bracket protrudes.

(7) A cable attachment method includes
attaching a cable including an electrical wire and a shield for shielding the electrical wire to a metal housing by using a metal terminal member, the housing being a housing that houses a storage battery or a powered device and has a connection space where the cable is connected, and the powered device being a device to which power is supplied from the electrical wire connected to the storage battery, wherein when attaching the cable to the housing, the cable is attached to a housing wall via the terminal member with the shield crimped by and connected to a crimping portion and with the electrical wire inserted through a through hole of a core-shaped magnetic body located in the connection space and attached to a bracket, the terminal member including a support portion, the crimping portion, and the bracket, the support portion being attached to the housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall.

(8) A metal terminal member for attaching a cable to a metal housing, the cable including in an outer peripheral portion of the cable a shield for shielding an electrical wire inside the cable, the housing being a housing that houses a storage battery or a powered device and has a connection space where the cable is connected, and the powered device being a device to which power is supplied from the electrical wire connected to the storage battery, wherein
the terminal member includes a support portion, a crimping portion, and a bracket, the support portion being attached to a housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall, and the cable is attached to the housing wall via the terminal member with the shield crimped by and connected to the crimping portion and with the electrical wire inserted through a through hole of a core-shaped magnetic body located in the connection space and attached to the bracket.

What is claimed is:

1. A cable attachment structure comprising:
a cable including in an outer peripheral portion of the cable a shield for shielding an electrical wire inside the cable;
a metal housing that houses a storage battery or a powered device, that has a connection space where the cable is connected, and that is electrically connected to a vehicle body, the powered device being a device to which power is supplied from the electrical wire connected to the storage battery; and
a metal terminal member including a support portion, a crimping portion, and a bracket, the support portion being attached to a housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall, wherein the cable is attached to the housing wall via the terminal member with the shield crimped by and connected to the crimping portion and with the electrical wire inserted through a through hole of a core-shaped magnetic body located in the connection space and attached to the bracket.

2. The cable attachment structure according to claim 1, wherein the storage battery is housed in the housing, and the electrical wire of the cable is connected to the storage battery in the connection space.

3. The cable attachment structure according to claim 1, wherein the powered device is housed in the housing, and the electrical wire of the cable is connected to the powered device in the connection space.

4. The cable attachment structure according to claim 1, wherein the powered device is a device configured to generate a common mode current in the cable when supplied with power.

5. The cable attachment structure according to claim 1, wherein the powered device is an inverter device configured to supply power to an electric motor used as a driving source for causing a vehicle to travel.

6. The cable attachment structure according to claim 1, wherein:
the housing wall has an insertion hole through which the electrical wire extending out of the cable is inserted; and
in the terminal member,
the support portion is in a form of a plate and is in surface contact with an end face of the housing wall that contacts with a lid that closes the connection space, and
the bracket protrudes from the support portion into the connection space, and the core-shaped magnetic body is attached to the bracket in such a manner that a direction in which the through hole extends coincides with a direction in which the bracket protrudes.

7. A cable attachment method comprising attaching a cable including an electrical wire and a shield for shielding the electrical wire to a metal housing by using a metal terminal member, the housing being a housing that houses a storage battery or a powered device and has a connection space where the cable is connected, and the powered device being a device to which power is supplied from the electrical wire connected to the storage battery, wherein when attaching the cable to the housing, the cable is attached to a housing wall via the terminal member with the shield crimped by and connected to a crimping portion and with the electrical wire inserted through a through hole of a core-shaped magnetic body located in the connection space and attached to a bracket, the terminal member including a support portion, the crimping portion, and the bracket, the support portion being attached to the housing wall adjacent to the connection space, the crimping portion being a part of the support portion attached to the housing wall that is located outside the connection space, the cable being able to be supported by the support portion with the shield of the cable being crimped by and connected to the crimping portion, the bracket being located on the support portion and being placed in the connection space by the support portion being attached to the housing wall.
